(19) United States
(12) Patent Application Publication
(10) Pub. No.: US 2002/0175014 A1
(43) Pub. Date: Nov. 28, 2002

(54) Three-wheeled recreational vehicle

(76) Inventor: Leon Hake, Perry, OK (US)

Correspondence Address: DUNLAP, CODDING & ROGERS P.C., PO BOX 16370, OKLAHOMA CITY, OK, 73114, US

(21) Appl. No.: 09/864,816

(22) Filed: May 24, 2001

(51) Int. Cl. B60K 17/30; B62K 5/02

(52) U.S. Cl. 180/213; 180/252

(57) ABSTRACT

A recreational vehicle comprises a frame having a front end, a rear end, a first side, a second side and a compartment sized to accommodate an operator. A first wheel assembly and a second wheel assembly are each pivotally connected to the first side of the frame of the recreational vehicle. A third wheel assembly is connected to the second side of the frame. A steering assembly is operably connected to the first and second wheel assemblies so as to rotate the first wheel assembly and the second wheel assembly simultaneously in opposite directions such that the frame is caused to travel in a first direction along a first radius and about a first point located a distance beyond the first side of the frame and so as to rotate the first wheel assembly and the second wheel assembly simultaneously in opposite directions such that the frame is caused to travel in a second direction along a second radius which is less than the first radius and about a second point located proximate the third wheel assembly whereby the frame is caused to move in a spinning motion when the first and second wheel assemblies are rotated so as to cause the frame to travel in the second direction.

### CROSS-REFERENCING TO RELATED APPLICATIONS

Not applicable.

### BACKGROUND OF THE INVENTION

1. Field of Invention

The present invention relates generally to three-wheeled vehicles, and more particularly, but not by way of limitation, to an improved three-wheeled recreational vehicle which is capable of traveling in a tight radius so as to permit the vehicle to be placed in a controlled spinning motion.

2. Description of Related Art

Vehicles utilizing only three wheels have been used in various capacities. For example, three-wheeled vehicles perform a variety of work-related tasks in the areas of agriculture and transportation of cargo and in cooperation with working implements. Three wheeled designs have been used for agricultural tasks to provide the vehicle with a tight turning radius in order to improve the vehicles maneuverability in the field. When transporting cargo, three-wheeled vehicles designs have been implemented to increase the vehicle's cargo space. Other three-wheeled designs have been utilized to direct and turn a working implement, such as a drill.

Three-wheeled vehicles are also used for recreation. The typical design is to utilize two fixed rear wheels and a single front wheel which is used to steer the vehicle. This design is used in producing three-wheeled motorcycles, as well as all terrain vehicles. Other types of recreational vehicles, commonly known as go-carts and all terrain vehicles, utilize a four-wheel design with two fixed rear wheels and two front wheels used to steer the vehicle.

While such recreational vehicles have met with success, operators of these vehicles often operate them in an unsafe manner by causing the vehicle to go into a spinning motion, commonly referred to as a “doughnut”. This is accomplished by the operator turning the steering wheel or handle bars sharply in one direction while maintaining the vehicle at a relatively high rate of speed. Such action can result in the operator losing control of the vehicle which in turn can lead to serious injury to the operator and damage to the vehicle.

To this end, a need exists for a recreational vehicle that is capable of traveling in a tight radius so as to cause the vehicle to move in a controlled, and thus safe, spinning motion. It is to such a vehicle that the present invention is directed.

### BRIEF SUMMARY OF THE INVENTION

The present invention is directed to a three-wheeled recreational vehicle. The recreational vehicle comprises a frame, a first wheel assembly, a second wheel assembly, a third wheel assembly, a motor and a steering assembly. The frame has a front end, a rear end, a first side, a second side and a compartment sized to accommodate an operator. The first wheel assembly is pivotally connected to the frame proximate the front end and the first side of the frame so as to be rotatable about a first vertical axis. The second wheel assembly is pivotally connected to the frame proximate the rear end and the first side of the frame in longitudinal alignment with the first wheel assembly so as to be rotatable about a second vertical axis. The third wheel assembly is connected to the frame proximate the second side of the frame and substantially an equidistant from the first and second wheel assemblies and so as to be rotatable about a third vertical axis. The first, second, and third wheel assemblies cooperate to rollingly support the frame. The motor is operably connected to at least one of the first and second wheel assemblies so as to propel the frame.

The steering assembly is operably connected to the first and second wheel assemblies so as to rotate the first wheel assembly and the second wheel assembly simultaneously in opposite directions such that the frame is caused to travel in a first direction along a first radius and about a first point located a distance beyond the first side of the frame. The steering assembly is also capable of rotating the first wheel assembly and the second wheel assembly simultaneously in opposite directions such that the frame is caused to travel in a second direction along a second radius which is less than the first radius and about a second point located proximate the third wheel assembly whereby the frame is caused to move in a controlled spinning motion when the first and second wheel assemblies are rotated so as to cause the frame to travel in the second direction.

Other features, aspects, and advantages of the present invention will become apparent from the following detailed description when read in conjunction with the accompanying drawings and appended claims.

### BRIEF DESCRIPTION OF THE SEVERAL VIEWS OF THE DRAWINGS

FIG. 1 is a perspective view of a vehicle constructed in accordance with the present invention.

FIG. 2 is a perspective view of a first wheel assembly.

FIG. 3 is a perspective view of a second wheel assembly.

FIG. 4 is a bottom plan view of the vehicle illustrating a steering assembly operably connected to the first and second wheel assemblies.

FIG. 5 is a bottom plan view of the vehicle illustrating the first and second wheels rotated to cause the vehicle to travel in a first direction around a first radius.

FIG. 6 is a bottom plan view illustrating the first and second wheels rotated to cause the vehicle to travel in a second direction around a second radius.

FIG. 7 is a side elevational view of a fourth wheel assembly.

### DETAILED DESCRIPTION OF THE INVENTION

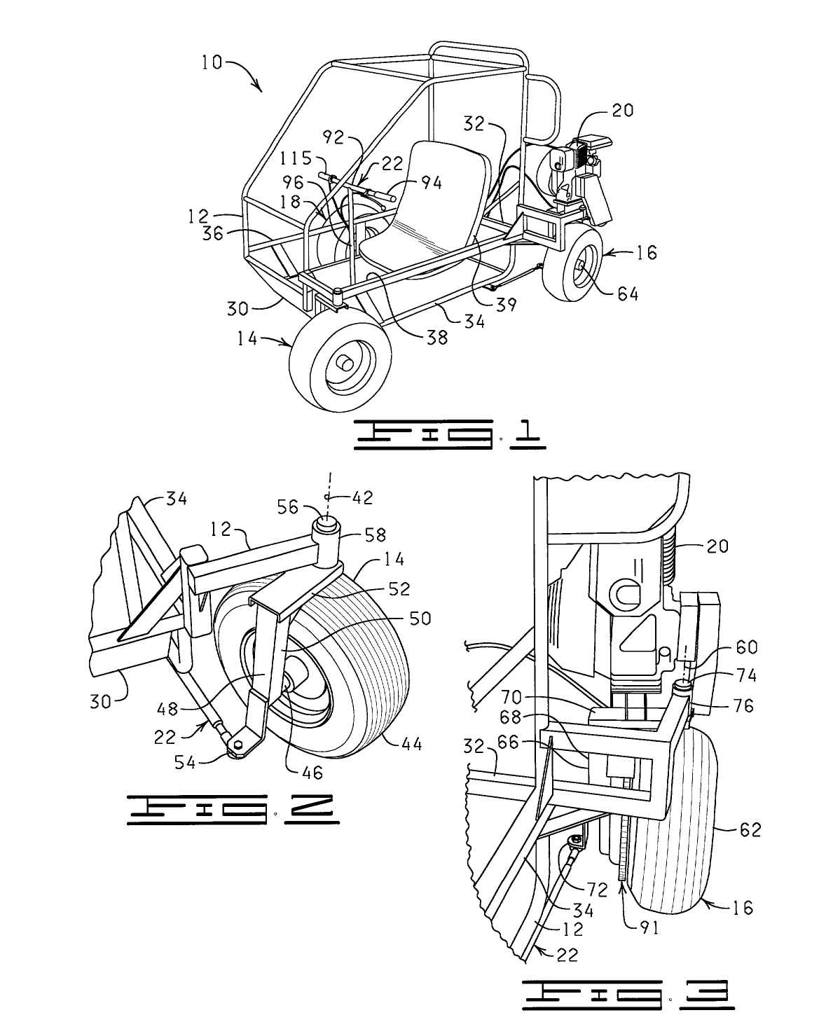

Referring now to the drawings, and more particularly to FIG. 1, a recreational vehicle 10 constructed in accordance with the present invention is illustrated. The recreational vehicle 10 includes a frame 12, a first wheel assembly 14, a second wheel assembly 16, a third wheel assembly 18, a motor 20, and a steering assembly 22.

The frame 12 may be constructed from iron or aluminum tubing. However, it should be understood that any suitable material may be used in constructing the frame 12 of the present invention. The frame 12 has a front end 30, a rear end 32, a first side 34, a second side 36 and defines a compartment 38 sized to accommodate an operator. The compartment 38 is provided with a seat 39 which is preferably centered along a longitudinal axis 40 (FIG. 4) of the frame 12. However, it should be noted that the seat 39 may be positioned at any suitable location between the front end 30 and rear end 32 and the first side 34 and the second side 36 of the frame 12.

Referring now to FIGS. 1 and 2, the first wheel assembly 14 is pivotally connected to the frame 12 proximate the front end 30 and the first side 34 of the frame 12 so as to be pivotable about a first vertical axis 42. The first wheel assembly 14 includes a first wheel 44 rotatably connected to a first wheel axle 46 which is fixed to a first spindle arm 48. The first spindle arm 46 includes a vertical portion 50, an upper horizontal portion 52, and a lower horizontal portion 54. The first wheel axle 46 is connected to the vertical portion 50 of the first spindle arm 48. The lower horizontal portion 54 of the first spindle arm 48 is connected to the steering assembly 22 in a manner to be discussed below. A first spindle 56 is connected to the upper horizontal portion 52 of the first spindle arm 48, and the first spindle 56 is rotatably received in a first bushing 58 of the frame 12.

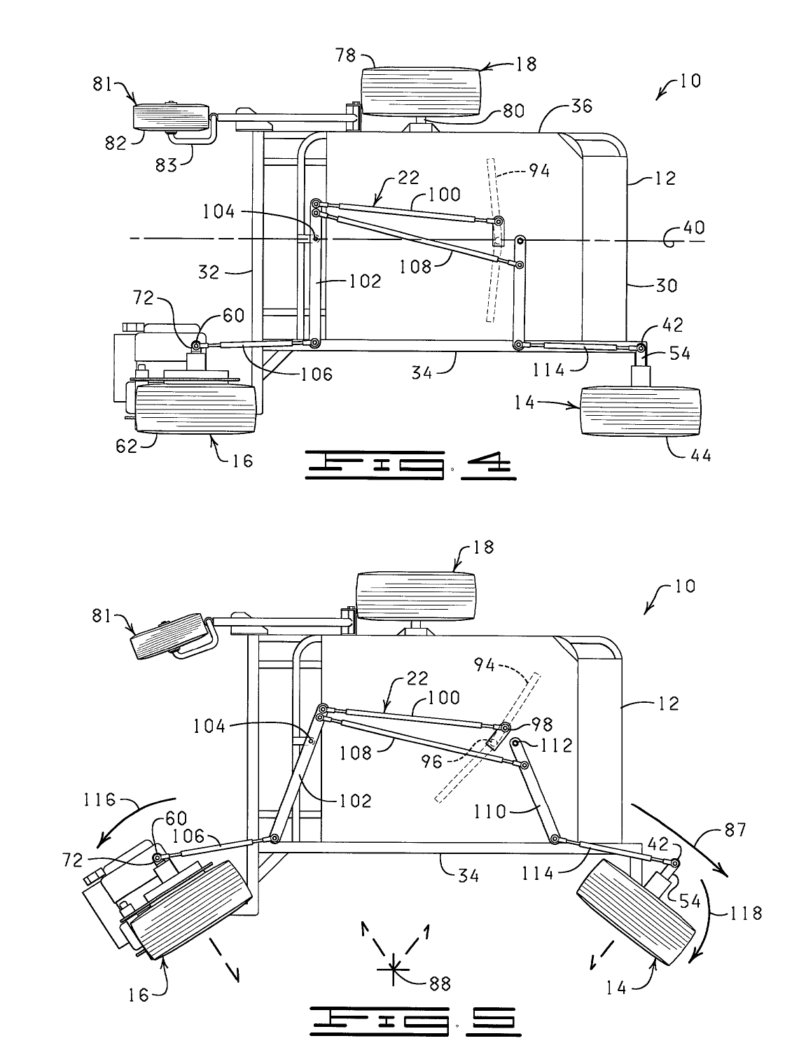

Referring now to FIGS. 1 and 3, the second wheel assembly 16 is pivotally connected to the frame 12 proximate the rear end 32 and the first side 34 of the frame 12, preferably in longitudinal alignment with the first wheel assembly 14, as best shown in FIG. 4. The second wheel assembly 16 is connected to the frame 12 so as to be pivotable about a second vertical axis 60. The second wheel assembly 16 includes a second wheel 62 rotatably connected to a second wheel axle 64 (FIG. 1) which is fixed to a second spindle arm 66. The second spindle arm 66 includes a vertical portion 68, an upper horizontal portion 70, and a lower horizontal portion 72. The second wheel axle 64 is connected to the vertical portion 68 of the second spindle arm 66. The lower horizontal portion 72 of the second spindle arm 66 is connected to the steering assembly 22 in a manner to be discussed below. A second wheel spindle 74 is connected to the upper horizontal portion 70 of the second spindle arm 66, and the second wheel spindle 74 is rotatably received in a second bushing 76 of the frame 12.

Shown in FIGS. 1 and 4-6, the third wheel assembly 18 cooperates with the first wheel assembly 14 and the second wheel assembly 16 to rollingly support the frame 12. The third wheel assembly 18 includes a third wheel 78 rotatably connected to a third wheel axle 80 which is fixed to the second side 36 of the frame 12. The third wheel assembly 18 is connected to the second side 36 of the frame 12 such that the third wheel 78 is positioned substantially an equidistance from the first wheel 44 and the second wheel 62. Furthermore, the first wheel assembly 14, the second wheel assembly 16, and the third wheel assembly 18 are preferably connected to the frame 12 so that the first, second, and third wheels 44, 62, and 78 are an equidistance from the longitudinal axis 40 of the frame 12.

As best shown in FIGS. 4-7, the recreational vehicle 10 of the present invention can also be provided with a fourth wheel assembly 81 to provide additional stability to the recreational vehicle 10 as the recreational vehicle 10 is caused to travel in a first direction, as described below. The fourth wheel assembly 81 includes a fourth wheel 82 rotatably connected to a fourth wheel axle 83. The fourth wheel axle 83 is provided with a vertical end portion 83a which is pivotally connected to one end of a suspension arm 84 so that the fourth wheel assembly 81 is freely pivotable about a vertical axis 85. The opposite end of the suspension arm 84 is pivotally connected to a portion of the frame 12 proximate the second side 36 thereof. A coil spring 86 is interposed between the suspension arm 84 and the frame 12 so as to bias the suspension arm 84, and thus the fourth wheel 82, in a downward direction to maintain the fourth wheel 82 in continuous contact with the ground.

The first wheel 44 of the first wheel assembly 14, the second wheel 62 of the second wheel assembly 16 and the third wheel 78 of the third wheel assembly 18 of the recreational vehicle 10 are all of uniform dimension and diameter, while the fourth wheel 82 of the fourth wheel assembly 81 preferably has a diameter less than the diameter of the first, second, and third wheels 44, 62, and 78. However, it should be understood that wheels of various dimensions and diameters may be used in the present invention.

As best shown in FIGS. 1 and 3, the motor 20 is mounted on the upper horizontal portion 70 of the second spindle arm 66 and operably linked to the second wheel 62 by a chain and sprocket assembly 91 to drive the second wheel 62, and in turn propel the frame 12 in a conventional manner. It will be appreciated that the size of the motor 20 can be varied.

Motors for propelling recreational vehicles, such as go-carts and all terrain vehicles are well known in the art. Thus, no further description of their components, construction, or operation is believed necessary in order for one skilled in the art to understand and implement the recreational vehicle 10 of the present invention.

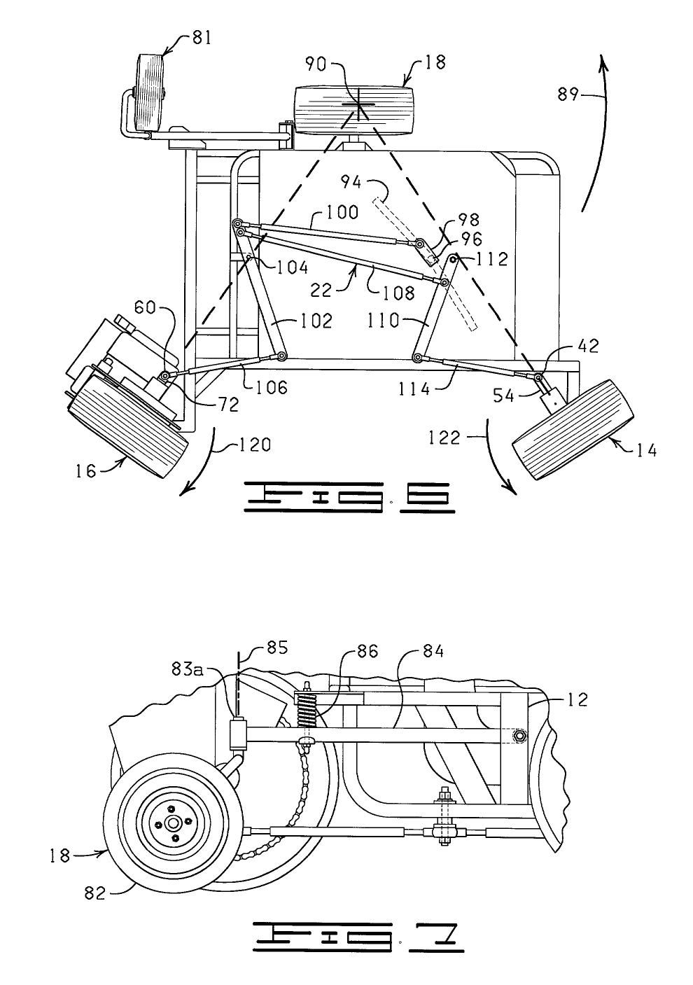

Referring now to FIGS. 1-6, the steering assembly 22 is operably connected to the first and second wheel assemblies 14 and 16 so as to rotate the first wheel assembly 14 about the first vertical axis 42 and the second wheel assembly 16 about the second vertical axis 60 simultaneously in opposite directions such that the frame 12 is caused to travel in a first direction along a first radius 87 and about a first point 88 (FIG. 5). The first point 88 is located a distance beyond the first side 34 of the frame 12. As shown in FIG. 6, the steering assembly 22 is also operably connected to the first and second wheel assemblies 14 and 16 so as to rotate the first wheel assembly 14 about the first vertical axis 42 and a second wheel assembly 16 about the second vertical axis 60 simultaneously in opposite directions such that the frame 12 is caused to travel in a second direction along a second radius 89 and a second point 90. The second radius 89 is less than the first radius 87 and the second point 90 is located approximate the third wheel assembly 18 when the first and second wheel assemblies 14 and 16 are fully turned in the second direction whereby the frame 12 is caused to move in a controlled spinning motion.

The steering assembly 22 includes a steering member 92 which is provided with a hand grip portion 94 and a steering column 96. The steering column 96 is extended upward from the frame 12 so that the hand grip portion 94 is operably positioned in front of the seat 39. The steering column 96 is rotatably connected to the frame 12 and fixed to one end of a steering plate 98 which extends substantially perpendicular from the steering column 96. The other end of the steering plate 98 is pivotally connected to one end of a first steering arm 100. The opposing end of the first steering arm 100 is pivotally connected to one end of a first linkage 102 which is pivotally connected to the frame 12 so as to define a pivot point 104 which is longitudinally aligned with the lower end of the steering column 96.

A first spindle connecting rod 106 is pivotally connected to the opposing end of the first linkage 102. The opposite end of the first spindle connecting rod 106 is pivotally connected to the lower horizontal portion 72 of the second spindle arm 66 of the second wheel assembly 16.

A second steering arm 108 has one end pivotally connected to the first linkage 102 at a position adjacent to where the first steering arm 100 is connected to the first linkage 102. The opposite end of the second steering arm 108 is pivotally connected to a second linkage 110. The second linkage 110 has one end pivotally connected to the frame 12 so as to define a pivot point 112 which is longitudinally aligned with the lower end of the steering column 96 and the pivot point 104 of the first linkage 102. The opposite end of the second linkage 110 is pivotally connected to a second spindle connecting rod 114 which is in turn pivotally connected to the lower horizontal portion 54 of the first spindle arm 48 of the first wheel assembly 14.

### Operation

To operate the recreational vehicle 10, an operator positions himself in the seat 39 and grips the hand grip portion 94 of the steering member 92. An accelerator 115 is actuated in a conventional manner to cause the motor 20 to drive the second wheel 62 of the second wheel assembly 16 and thus propel the frame 12 in a forward direction. It will be appreciated that the recreational vehicle 10 will continue in the forward direction so long as the first and second wheels 44 and 62 are maintained in an aligned relationship with respect to one another, as shown in FIG. 4.

Upon the operator rotating the steering column 96 in a counterclockwise direction relative to the operator, or clockwise relative to the bottom of the frame 12, the steering plate 98 is caused to rotate so as to exert a pulling force on the first steering arm 100. Consequently, the first linkage 102 is rotated about pivot point 104, as shown in FIG. 5, so as to exert a pushing force on the first spindle connecting rod 106 which rotates the second wheel assembly 16 about the second vertical axis 60 in a first direction represented by the arrow 116. Simultaneously, the second steering arm 108 exerts a pushing force on the second linkage 110 thus causing the second linkage 110 to rotate about the pivot point 112. Rotation of the second linkage 110, as shown in FIG. 5, exerts a pushing force on the second spindle connecting rod 114 which causes the first wheel assembly 14 to rotate about the first vertical axis 42 in a first direction represented by arrow 118. The first direction 116 of the second wheel assembly 16 is opposite to the first direction 118 of the first wheel assembly 14.

With each of the first and second wheel assemblies 14 and 16 rotated fully in the first directions 118 and 116, respectively, the frame 12 is caused to travel in the first direction along the first radius 87 and about the first point 88. Because the first point 88, which is defined by the intersection of the first wheel axle 46 and the second wheel axle 64 is located a distance beyond the first side 34 of the frame 12, the first radius 87 is relatively gradual.

In contrast, upon the operator rotating the steering column 96 in a clockwise direction relative to the operator, or clockwise relative to the bottom of the frame 12, the steering plate 98 is caused to rotate so as to exert a pushing force on the first steering arm 100. Consequently, the first linkage 102 is rotated about pivot point 104, as shown in FIG. 6, so as to exert a pulling force on the first spindle connecting rod 106 which rotates the second wheel assembly 16 about the second vertical axis 60 in a second direction represented by the arrow 120. Simultaneously, the second steering arm 108 exerts a pulling force on the second linkage 110 thus causing the second linkage 110 to rotate about the pivot point 112. Rotation of the second linkage 110, as shown in FIG. 6, exerts a pulling force on the second spindle connecting rod 114 which causes the first wheel assembly 14 to rotate about the first vertical axis 42 in a second direction represented by arrow 122. The second direction 120 of the second wheel assembly 16 is opposite to the second direction 122 of the first wheel assembly 14.

With each of the first and second wheel assemblies 14 and 16 rotated fully in the second directions 122 and 120, respectively, so that the intersection of the first wheel axle 46 and the second wheel axle 64 is located proximate the third wheel 78, the frame 12 is caused to travel in the second direction along the second radius 89 and about the second point 90. Because the second point 90 is located proximate the third wheel 78, and preferably intersects the third wheel 78, the frame 12 is caused to rotate about the third wheel 78 and thus travel in a controlled spinning motion so long as the operator maintains the first and second wheel assemblies 14 and 16 fully in the second directions 122 and 120.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A recreational vehicle, comprising:
a frame having a front end, a rear end, a first side, a second side, and a seat sized to accommodate an operator;
a first wheel assembly pivotally connected to the frame proximate the front end and the first side of the frame so as to be rotatable about a first vertical axis;
a second wheel assembly pivotally connected to the frame proximate the rear end and the first side of the frame in longitudinal alignment with the first wheel assembly so as to be rotatable about a second vertical axis;
a third wheel assembly connected to the frame proximate the second side of the frame such that the first, second and third wheel assemblies cooperate to rollingly support the frame, the third wheel assembly positioned substantially an equidistance from the first and second wheel assemblies;
a motor operably connected to at least one of the first and second wheel assemblies so as to propel the frame; and
a steering assembly operably connected to the first and second wheel assemblies so as to rotate the first wheel assembly about the first vertical axis and the second wheel assembly about the second vertical axis simultaneously in opposite directions such that the frame is caused to travel in a first direction along a first radius and about a point located a distance beyond the first side of the frame and so as to rotate the first wheel assembly about the first vertical axis and the second wheel assembly about the second vertical axis simultaneously in opposite directions such that the frame is caused to travel in a second direction along a second radius which is less than the first radius and about a second point located proximate the third wheel assembly whereby the frame is caused to move in a substantially spinning motion when the first and second wheel assemblies are rotated so as to cause the frame to travel in the second direction.

2. The recreational vehicle of claim 1 wherein the first wheel assembly has a first wheel, the second wheel assembly has a second wheel, and the third wheel has a third wheel and wherein the first wheel, the second wheel and the third wheel are all of uniform diameter.

3. The recreational vehicle of claim 2 wherein the frame has a longitudinal axis and wherein each of the first wheel, the second wheel, and the third wheel is positioned an equidistance from the longitudinal axis of the frame.

4. The recreational vehicle of claim 2 wherein the seat of the frame is centered on the longitudinal axis of the frame.

5. The recreational vehicle of claim 2 further comprises a fourth wheel assembly connected to the frame proximate the rear end and the second side of the frame so as to be freely rotatable about a fourth vertical axis and so as to stabilize the frame.

6. The recreational vehicle of claim 5 wherein the wherein the fourth wheel assembly includes a fourth wheel which rotates about a fourth wheel axle, the fourth wheel having a diameter less than the diameter of the first, second and third wheels.

7. A recreational vehicle, comprising:
a frame having longitudinal axis, a front end, a rear end, a first side, a second side, and a seat sized to accommodate an operator centrally positioned on the longitudinal axis;
a first wheel assembly pivotally connected to the frame proximate the front end and the first side of the frame so as to be rotatable about a first vertical axis, the first wheel assembly having a first wheel;
a second wheel assembly pivotally connected to the frame proximate the rear end and the first side of the frame so as to be rotatable about a second vertical axis, the second wheel assembly having a second wheel in longitudinal alignment with the first wheel of the first wheel assembly;
a third wheel assembly connected to the frame proximate the second side of the frame such that the first, second and third wheel assemblies cooperate to rollingly support the frame, the third wheel assembly having a third wheel positioned substantially an equidistant from the first and second wheels and the first, second and third wheel each being positioned an equidistance from the longitudinal axis of the frame;
a motor operably connected to at least one of the first and second wheels so as to propel the frame; and
a steering assembly operably connected to the first and second wheel assemblies so as to rotate the first wheel assembly about the first vertical axis and the second wheel assembly about the second vertical axis simultaneously in opposite directions such that the frame is caused to travel in a first direction along a first radius and about a point located a distance beyond the first side of the frame and so as to rotate the first wheel assembly about the first vertical axis and the second wheel assembly about the second vertical axis simultaneously in opposite directions such that the frame is caused to travel in a second direction along a second radius which is less than the first radius and about a second point located proximate the third wheel assembly whereby the frame is caused to move in a substantially spinning motion when the first and second wheel assemblies are rotated so as to cause the frame to travel in the second direction.

8. The recreational vehicle of claim 7 further comprises a fourth wheel assembly connected to the frame proximate the rear end and the second side of the frame so as to be freely rotatable about a fourth vertical axis and so as to stabilize the frame.

9. The recreational vehicle of claim 8 wherein the wherein the fourth wheel assembly includes a fourth wheel which rotates about a fourth wheel axle, the fourth wheel having a diameter less than the diameter of the first, second and third wheels.

10. The recreational vehicle of claim 7 wherein the first wheel, the second wheel and the third wheel are all of uniform diameter.

11. The recreational vehicle of claim 10 further comprises a fourth wheel assembly connected to the frame proximate the rear end and the second side of the frame so as to be freely rotatable about a fourth vertical axis and so as to stabilize the frame.

12. The recreational vehicle of claim 11 wherein the wherein the fourth wheel assembly includes a fourth wheel which rotates about a fourth wheel axle, the fourth wheel having a diameter less than the diameter of the first, second and third wheels.
